(19) United States
(12) Patent Application Publication
(10) Pub. No.: US 2009/0000840 A1
(43) Pub. Date: Jan. 1, 2009

(54) Wheel Drive Apparatus

(75) Inventor: Satoshi Murata, Aichi-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, TOYOTA-SHI (JP)

(21) Appl. No.: 12/159,098

(22) PCT Filed: Jan. 9, 2007
(86) PCT No.: PCT/IB2007/000081

§ 371 Date: Jun. 25, 2008

(30) Foreign Application Priority Data
Jan. 18, 2006 (JP) 2006-010487

(51) Int. Cl. B60K 7/00

(52) U.S. Cl. 180/65.5; 180/65.6

(57) ABSTRACT

A wheel drive apparatus drives a wheel by a motor provided inside a wheel member. A planetary gear speed reducer is coupled to an output shaft of the motor. An inner-ring side member is disposed between an inner ring of an axle bearing and the outer periphery of the speed reducer, and is secured to a suspension apparatus of the vehicle. An outer-ring side member is secured to an outer-ring of the axle bearing, and is supported for rotation relative to the inner-ring side member. The wheel member is secured to the outer-ring side member. The power transmission member is disk shaped, and the outer periphery of the power transmission member extends to the location of the outer-ring side member and is coupled to the outer-ring side member.

### BACKGROUND OF THE INVENTION

1. Field of the Invention

The invention relates to the structure of a wheel drive apparatus having an in-wheel motor using a speed reducer.

2. Description of the Related Art

In-wheel motor vehicles are known that can control braking and driving force for respective wheels independently of each other. There are several types of in-wheel motors. For example, some in-wheel motors transmit the output of the motor to the wheel via a speed reducer. Other in-wheel motors are direct-drive in-wheel motors that rotate the wheel using the motor directly without using a speed reducer. The former includes, for example, in-wheel motors with the wheel secured to the inner ring side of an axle bearing, and others with the wheel secured to the outer-ring side of an axle bearing. Japanese Patent Application Publication JP-A-05-238276 describes an in-wheel motor with a wheel secured to the outer-ring side of an axle bearing.

In the in-wheel motor described in JP-A-05-238276 mentioned above, the speed reducer and the axle bearing are arranged in series on the axle. Therefore, the in-wheel motor is made larger in the axial direction, which imposes significant restrictions on the design of a suspension apparatus.

The invention has been made in view of the foregoing problem of the related art, and therefore provides a technology to allow an in-wheel motor to be made smaller in the axial direction.

### SUMMARY OF THE INVENTION

An aspect of the invention provides a wheel drive apparatus including: a motor provided in a wheel; a speed reducer coupled to an output shaft of the motor and extending to the outside of the wheel; a bearing disposed on the outer periphery of the speed reducer; a substantially cylindrical inner-ring side member disposed between an inner ring of the bearing and the outer periphery of the speed reducer and secured to a suspension apparatus of a vehicle; a substantially cylindrical outer-ring side member secured to an outer-ring of the bearing and supported for rotation relative to the inner-ring side member; a wheel member secured to the outer-ring side member; and a power transmission member that transmits an output from the speed reducer to the outer-ring side member.

In accordance with this aspect, the output generated by the motor is reduced in speed by the speed reducer, and transmitted to the outer-ring side member disposed on the outer periphery of the speed reducer through the power transmission member to rotate the wheel member. By disposing the speed reducer on the inner ring side of the bearing and providing a separate power transmission member that transmits the output from the speed reducer to the outer-ring side of the bearing in this way, the wheel drive apparatus can be made smaller in the axial direction in comparison to the arrangement where the speed reducer and the bearing are disposed in series.

In the above aspect, the power transmission member may have a disk shape, and the outer periphery of the power transmission member may extend to a position where the outer-ring side member is located and be coupled to the outer-ring side member. With the above construction, because the disk-like power transmission member extends to the location of the outer-ring side member, the speed reducer and the bearing can be covered with the power transmission member. Thus, intrusion of foreign matter into the speed reducer and the bearing from outside is prevented. In addition, because there is no need to provide a separate protective case, the number of parts is reduced.

Also, in the above aspect, the speed reducer may have a plurality of planetary gear mechanisms disposed on an axle.

Also, in the above aspect, the planetary gear mechanism may be including: a sun gear that receives the output from the output shaft of the motor; an outer gear provided on the inner periphery of the inner-ring side member; a plurality of planetary gears in mesh with and disposed between the sun gear and the outer gear so as to revolve around the sun gear; and a planetary carrier secured to the central shafts of the plurality of planetary gears.

In the above aspect, the outer-ring side member may have a plurality of projections extending in the outward direction of the wheel and located at positions where the outer-ring side member is coupled to the power transmission member, and the power transmission member may have recesses for receiving the plurality of projections at positions along the outer periphery of the power transmission member corresponding to the projections. With the above construction, because the two members are coupled by fitting the projections and the recesses, the rotational driving force can be transmitted with a minimal loss, and the wheel drive apparatus can be made smaller in the axial direction. Further, in the above construction, the projections of the outer-ring side member may be flat. Moreover, in the above construction, the projections of the outer-ring side member and the recesses of the power transmission member may have substantially the same size in the circumferential direction as each other.

In the above aspect, the distal ends of the projections of the outer-ring side member may be bent inward from the power transmission member, so that the projections are pressed into the power transmission member. With the above construction, the connection between the outer-ring side member and the power transmission member can be strengthened, and play (or looseness) in the connection is reduced. Therefore, noise during rotational drive can be reduced.

In accordance with the invention, the wheel having an in-wheel motor for driving the outer-ring side of an axle bearing can be made smaller than in the case where the respective components are arranged in series.

### BRIEF DESCRIPTION OF THE DRAWINGS

The foregoing and/or further objects, features and advantages of the invention will become more apparent from the following description of preferred embodiment with reference to the accompanying drawings, in which like numerals are used to represent like elements and wherein:

FIG. 1 is a cross sectional view of the structure of a wheel drive apparatus in accordance with an embodiment of the invention;

FIG. 2 is an enlarged cross sectional view of an in-wheel motor shown in FIG. 1;

FIG. 3 illustrates a power transmission member and an outer-ring side member fitted together before being crimped;

FIG. 4 illustrates the power transmission member and the outer-ring side member crimped together;

FIG. 5 illustrates a state where the power transmission member and the outer-ring side member are crimped together over the entire periphery; and

FIG. 6 is an enlarged view of the part A of FIG. 5.

### DETAILED DESCRIPTION OF THE PREFERRED EMBODIMENTS

In the following description, the invention will be described in more detail in terms of example embodiments.

The following describes a wheel drive apparatus having an in-wheel motor in accordance with an embodiment of the invention. The wheel drive apparatus has a motor for each wheel, and transmits an output from the motor to a wheel member via a speed reducer to drive the wheel.

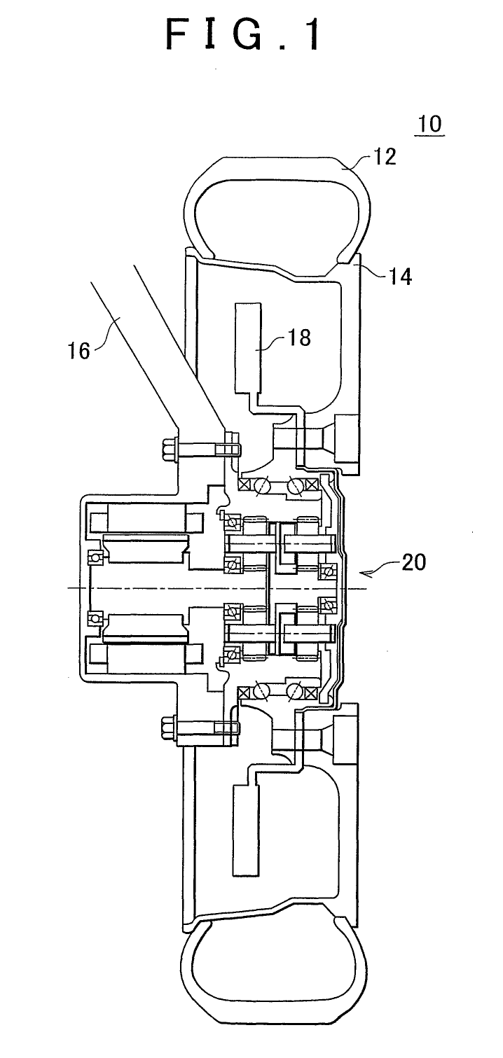

FIG. 1 illustrates the structure of a wheel drive apparatus 10 in cross section. A tire 12 is mounted on the rim of a wheel member 14. An in-wheel motor 20 is disposed at the center of the wheel member 14. The in-wheel motor 20 is coupled via a knuckle 16 to a lower arm, an upper arm, and a tie rod (which are not shown) of the vehicle. The lower arm and the upper arm are connected to a vehicle body (not shown), and support the wheel including the in-wheel motor 20. The wheel drive apparatus 10 also has a brake disk 18 that is clamped by a brake caliper (not shown) to generate braking force.

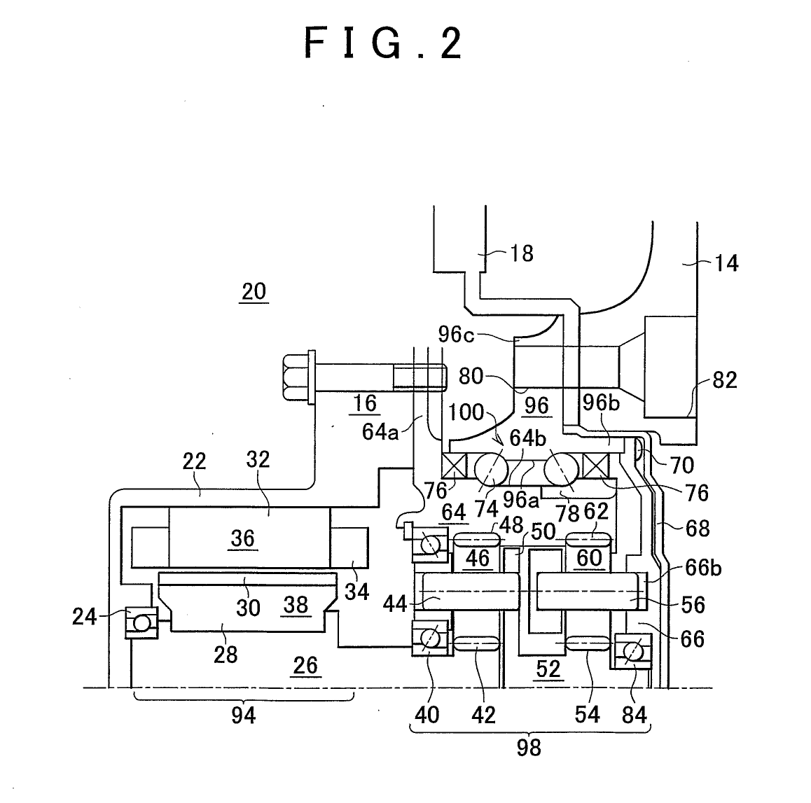

FIG. 2 is an enlarged cross sectional view of the in-wheel motor 20 shown in FIG. 1. In FIG. 2, the left side of the drawing corresponds to the inner side of the wheel, and the right side corresponds to the outer side of the wheel.

The knuckle 16 is connected to a cylindrical motor case 22 housing a motor 94. An output shaft 26 is disposed coaxially with an axle in the motor case 22. The output shaft 26 is supported for free rotation by bearings 24 and 40. A rotor 38 is attached to the output shaft 26. The rotor 38 includes a laminated electromagnetic steel plate 28 and a plurality of permanent magnets 30 secured to the outer periphery of the electromagnetic steel plate 28. A stator 36 is disposed around the outer periphery of the rotor 38. The stator 36 includes an iron core 32 of a laminated electromagnetic steel plate, and a plurality of coils 34 for three phases formed by winding wires within coil slots formed around respective teeth portions of the iron core 32. The rotor 38 and the stator 36 are arranged with a predetermined gap therebetween. The motor case 22 is sealed tightly to prevent intrusion of foreign matter into the stator 36 and the rotor 38 from outside. In the motor 94, currents are supplied to the plurality of coils 34 consecutively at predetermined timing so that a rotating magnetic field is generated in the stator 36, which rotates the rotor 38.

A planetary gear speed reducer 98 is disposed on the output shaft 26 of the motor 94. The planetary gear speed reducer 98 has planetary gear mechanisms for two stages. A first sun gear 42 of the first-stage planetary gear mechanism is formed at the distal end of the output shaft 26. The first sun gear 42 is in mesh with a plurality of first planetary gears 46. It should be noted that only one first planetary gear 46 is shown in FIG. 2. The first planetary gear 46 is also in mesh with a first outer gear 48 formed on the inner peripheral surface of an inner-ring side member 64 secured to and supported by the knuckle 16. The first planetary gears 46 revolve around the first sun gear 42.

The plurality of first planetary gears 46 are secured to a shaft 44. The shaft 44 is secured to a planetary carrier 50, and transmit the revolving movement of the first-stage planetary gear mechanism to the second-stage planetary gear mechanism. A shaft 52, which extends coaxially with the axle, is connected to the center of the planetary carrier 50. The shaft 52 is supported for free rotation by a bearing 84. A second sun gear 54 of the second-stage planetary gear mechanism is formed on the shaft 52. The second sun gear 54 is in mesh with a plurality of second planetary gears 60. It should be noted that only one second planetary gear 60 is shown in FIG. 2. The second planetary gear 60 is also in mesh with a second outer gear 62 formed on the inner peripheral surface of the inner-ring side member 64. The second planetary gears 60 revolve around the second sun gear 54. The gears of the planetary gear mechanisms are helical gears so that the gears receive thrust loads in the axial direction.

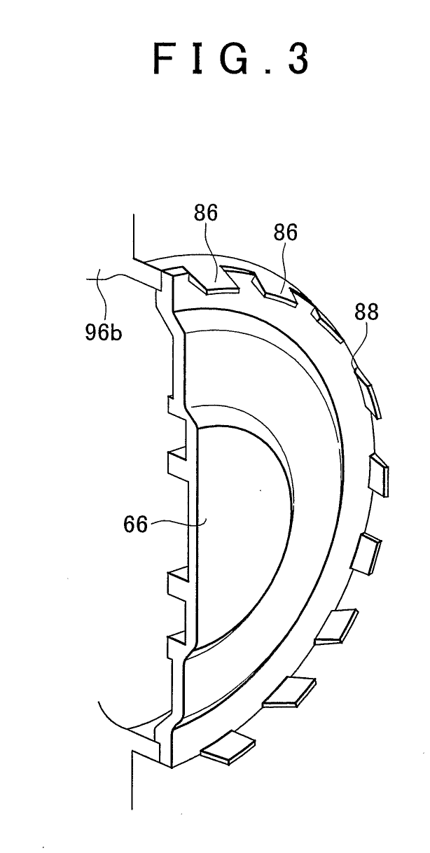

Shafts 56, which are secured to the plurality of the second planetary gears 60, are secured to a power transmission member 66. The power transmission member 66 is located on the outside of the planetary gear speed reducer 98, and has a substantially disk shape as partly shown in FIG. 3. The outer periphery of the power transmission member 66 extends in radial directions of the wheel, further outward than the outer periphery of the planetary gear speed reducer 98. A recess 66b for supporting the shaft 56 of the second planetary gear 60 is formed in the inner side of the power transmission member 66. The power transmission member 66 also functions as a planetary carrier for the second-stage planetary gear mechanism, which extracts power from the revolving movement of the second planetary gear 60. Although a two-stage planetary gear mechanism is used to obtain a large speed reduction ratio in this embodiment, a single-stage planetary gear mechanism may also be used. Alternatively, a triple-stage or greater planetary gear mechanism may also be used.

An axle bearing 100 is mounted on the outer periphery of the planetary gear speed reducer 98. The axle bearing 100 includes an inside inner race 64b, an outside inner race 78, an outer race 96a, a ball for bearing 74, and a dust seal 76. The inside inner race 64b is formed in the substantially cylindrical inner-ring side member 64 which has a flange portion 64a secured to the knuckle 16 at one end. The outside inner race 78 is secured to the inner-ring side member 64. The outer race 96a is formed on the inner peripheral surface of an outer-ring side member 96. The ball 74 rolls in a path defined between the inner races 64b, 78 and the outer race 96a. The dust seal 76 is provided between the inner races 64b, 78 and the outer race 96a to prevent intrusion of foreign matter into the bearing from outside. The outer-ring side member 96 is supported for free rotation relative to the inner-ring side member 64 via the axle bearing 100. In the construction described above, the outer race 96a and the inner races 64b, 78 of the axle bearing 100 are formed in the outer-ring side member 96 and the inner-ring side member 64, respectively. However, the invention is not limited thereto, but an outer race and an inner race as separate parts may be secured to the outer-ring side member and the inner-ring side member, respectively.

The outer-ring side member 96 includes a cylindrical portion 96b on the inner periphery of which the outer race 96a is formed, and a flange portion 96c extending outwardly in the radial direction of the wheel from the cylindrical portion 96b. A plurality of female screw holes 80 is formed in the flange portion 96c. A plurality of boltholes 82 is formed in the wheel member 14 at positions corresponding to the female screw holes 80. Hub bolts (not shown) screwed into the female screw holes 80 through the bolt holes 82 secure the wheel member 14 and the brake disk 18 to the outer-ring side member 96.

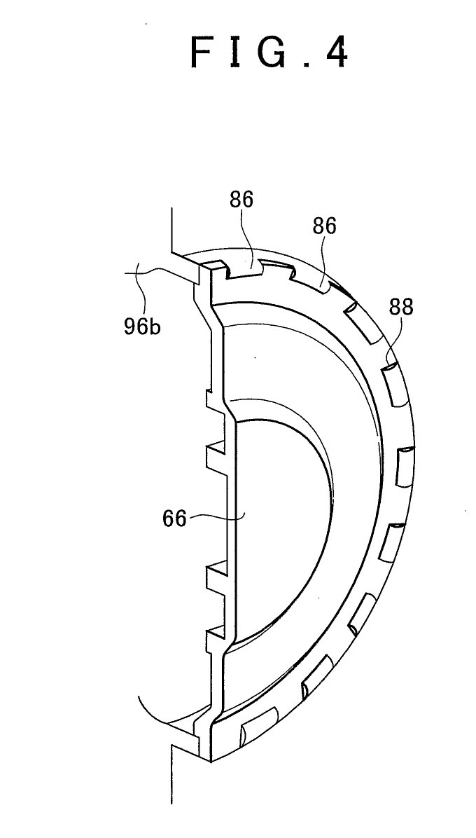

The outer periphery of the power transmission member 66 extends to a position where the cylindrical portion 96b of the outer-ring side member 96 is located. The outer peripheral end of the power transmission member 66 and the cylindrical portion 96b of the outer-ring side member 96 are coupled together by a crimp 70. The structure of the crimp 70 will be described in detail later with reference to FIGS. 3 and 4.

An ornament plate 68 for decorative purposes is disposed on the outer side of the power transmission member 66.

In the wheel drive apparatus 10 in accordance with this embodiment, the wheel member 14, the brake disk 18, the outer-ring side member 96, the axle bearing 100, the inner-ring side member 64, and the planetary gear speed reducer 98 are concentrically arranged from the outside to the inside.

With the in-wheel motor as a component of the wheel drive apparatus 10 in accordance with this embodiment, the number of power transmission parts and the installation space of such parts, which would be required in the case where an output of a single motor is distributed to each wheel, can be reduced. The power transmission loss can also be reduced.

Now, the transmission path of power generated by the motor 94 according to the embodiment will be described.

First, in response to a command from a vehicle control unit (not shown), the motor 94 is driven to rotate the rotor 38 relative to the stator 36. This rotational driving force is transmitted to the planetary gear speed reducer 98 via the output shaft 26. As the output shaft 26 rotates, the first sun gear 42 also rotates, which causes the first planetary gears 46 to rotate on their axes and also revolve around the first sun gear 42. The planetary carrier 50 extracts power from the revolving movement of the first planetary gears 46. The second sun gear 54 formed on the shaft 52 connected to the planetary carrier 50 rotates by the extracted power. As a result, the second planetary gears 60 rotate on their axes and also revolve around the second sun gear 54. The power transmission member 66 extracts power from the revolving movement of the second planetary gears 60. The extracted power is transmitted to provide rotational driving force to the outer-ring side member 96 coupled to the power transmission member 66 by the crimp 70. Finally, the wheel member 14 secured to the outer-ring side member 96 rotates to drive the wheel.

As described above, the output of the planetary gear speed reducer 98 is transmitted via the power transmission member 66 to the outer-ring side member 96 and then the wheel member 14. The outer-ring side member 96, the brake disk 18, and the wheel member 14 rotate relative to the inner-ring side member 64 secured to the knuckle 16.

A wheel drive apparatus having a motor, a speed reducer, an axle bearing, a hub, and a wheel member arranged in series has large total length in the axial direction. Meanwhile, in the wheel drive apparatus according to this embodiment, the speed reducer and the wheel member are respectively located on the inner side and the outer side with respect to the bearing in the radial direction of the wheel. Consequently, the wheel drive apparatus 10 can be made smaller in the axial direction than the former arrangement where the respective components are disposed in series. In addition, in the wheel drive apparatus according to this embodiment, the outer gear of the planetary gear mechanism is formed integrally with the inner peripheral surface of the inner-ring side member 64. Thus, the number of parts can be reduced and the structure of the apparatus can be simplified, compared to the arrangement where the outer gear is provided as a separate component.

In this embodiment, the outer periphery of the power transmission member 66 extends to a position where the cylindrical portion 96b of the outer-ring side member 96 is located. With this construction, the planetary gear speed reducer 98 and the axle bearing 100 are covered with the power transmission member 66 and sealed tightly therewith from the outside of the vehicle. Consequently, intrusion of foreign matter into the planetary gear speed reducer 98 and the axle bearing 100 from outside the vehicle can be prevented. The ornament plate 68 does not provide a sealing function and therefore may not be provided.

Now, the following is a description of how the power transmission member 66 and the outer-ring side member 96 are coupled together.

FIG. 3 illustrates the power transmission member 66 and the outer-ring side member 96 before being crimped. A plurality of flat projections 86 extending to the outside of the wheel and having a predetermined length in the circumferential direction are formed on the end surface of the cylindrical portion 96b of the outer-ring side member 96 facing the outer side of the wheel. On the other hand, recesses 88 are formed along the outer periphery of the power transmission member 66 to receive the projections 86 of the outer-ring side member. The recesses 88 have substantially the same dimensions as the projections 86. The outer-ring side member 96 and the power transmission member 66 are coupled together by fitting the projections 86 of the outer-ring side member 96 into the recesses 88 of the power transmission member 66. When they are coupled, the projections 86 of the outer-ring side member 96 project outward from the power transmission member 66. With the construction described above, the transmission loss of the rotational driving force can be reduced, and also the power transmission member 66 can receive thrust force on the gears of the planetary gear speed reducer 98.

FIG. 4 illustrates the power transmission member 66 and the outer-ring side member 96 crimped together. From the state shown in FIG. 3 where the outer-ring side member 96 and the power transmission member 66 are coupled together, the distal ends of the projections 86 are bent inward from the power transmission member 66 to form the crimp 70. With the crimp 70 formed in this way, the distal ends of the projections 86 are pressed to the power transmission member 66.

By bending the projections 86, portions of the projections 86 fitted in the recesses 88 are deformed slightly to the circumference of the power transmission member 66 to fill gaps around the fitted portions. As a result, play (or looseness) between the projections 86 and the recesses 88 is reduced, and the outer-ring side member 96 and the power transmission member 66 can be strongly coupled together. This construction also reduces noise during rotational drive. In addition, the connection between the power transmission member 66 and the outer-ring side member 96 is downsized, and the wheel drive apparatus 10 can be made smaller in the axial direction. Further, the planetary gear speed reducer 98 can be sealed relatively easily.

The invention has been described above by way of an embodiment thereof. The embodiment is intended for illustration purposes only, and one or more of the components thereof may be modified.

Although a planetary gear mechanism is used as the speed reducer in the embodiment, alternative types of speed reducer may be used.

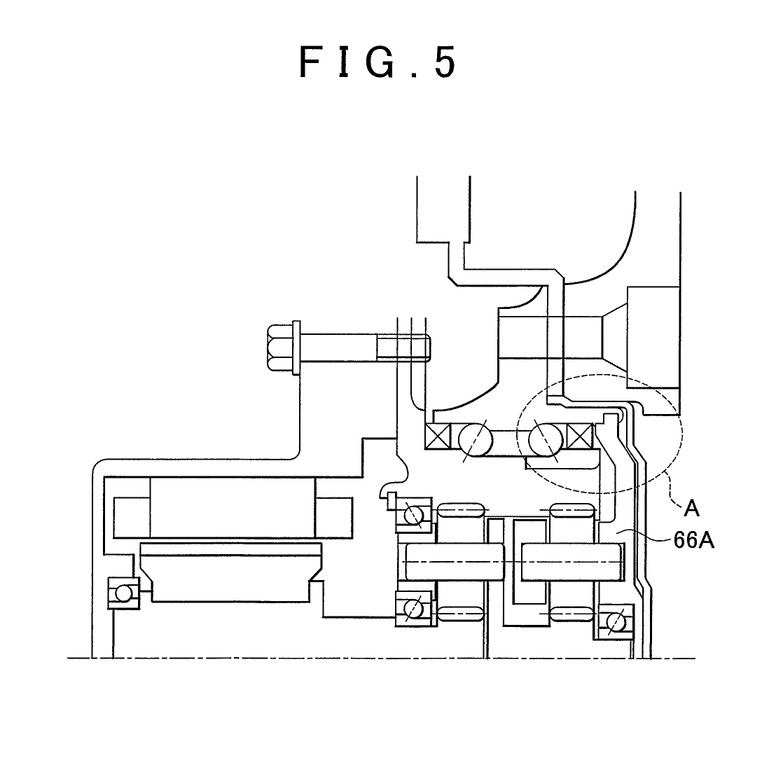

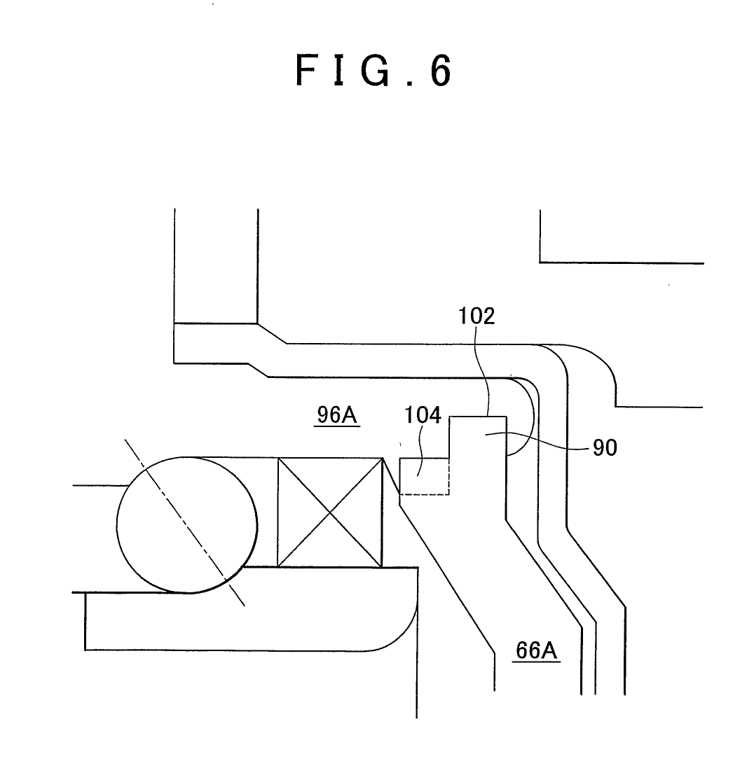

Although the projections of the power transmission member 66 and the recesses of the outer-ring side member 96 are formed at corresponding positions with respect to each other in the embodiment, they may be formed at non-corresponding positions. For example, FIG. 5 illustrates a state where a power transmission member 66A and an outer-ring side member 96A are crimped together over the entire periphery. FIG. 6 is an enlarged view of the part A of FIG. 5. In this example, as shown in FIG. 6, projections 90 formed on the power transmission member 66A are fitted into recesses 102 formed in the outer-ring side member 96A. The power transmission member 66A and the outer-ring side member 96A are crimped together by a crimp 104. This construction improves the crimping strength.

While the invention has been described with reference to example embodiments thereof, it should be understood that the invention is not limited to the example embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

1-6. (canceled)

7. A wheel drive apparatus, comprising:
a motor, provided in a wheel;
a speed reducer coupled to an output shaft of the motor;
a bearing, disposed on an outer periphery of the speed reducer;
a substantially cylindrical inner-ring side member disposed between an inner ring of the bearing and the outer periphery of the speed reducer and secured to a suspension apparatus of a vehicle;
a substantially cylindrical outer-ring side member secured to an outer-ring of the bearing and supported for rotation relative to the inner-ring side member;
a wheel member, secured to the outer-ring side member;
a power transmission member that transmits an output from the speed reducer to the outer-ring side member, wherein
the power transmission member is disk shaped, and an outer periphery of the power transmission member extends to the location of the outer-ring side member and is coupled to the outer-ring side member,
the outer-ring side member includes a plurality of projections extending in an outward direction of the wheel and located at positions where the outer-ring side member is coupled to the power transmission member,
the power transmission member includes recesses for receiving the plurality of projections at positions along the outer periphery of the power transmission member corresponding to the projections, and
ends of the projections of the outer-ring side member are bent inward from the power transmission member, so that the projections are pressed into the power transmission member.

8. The wheel drive apparatus according to claim 7, wherein
the speed reducer includes a plurality of planetary gear mechanisms disposed on an axle.

9. The wheel drive apparatus according to claim 8, wherein
the planetary gear mechanism comprising:
a sun gear that receives an output from the output shaft of the motor;
an outer gear provided on an inner periphery of the inner-ring side member;
a plurality of planetary gears in mesh with and disposed between the sun gear and the outer gear so as to revolve around the sun gear; and
a planetary carrier secured to central shafts of the plurality of planetary gears.

10. The wheel drive apparatus according to claim 7, wherein
the projections of the outer-ring side member are flat.

11. The wheel drive apparatus according to claim 7, wherein
the projections of the outer-ring side member and the recesses of the power transmission member have substantially the same size in a circumferential direction as each other.
